(19) United States
(12) Patent Application Publication
(10) Pub. No.: US 2026/0062919 A1
(43) Pub. Date: Mar. 5, 2026

(54) LIGHT WEIGHT ROOFING MEMBRANE WITH IMPROVED MECHANICAL PERFORMANCE

(71) Applicant: CARLISLE CONSTRUCTION MATERIALS, LLC, Carlisle, PA (US)

(72) Inventors: Xuan ZHANG, Carlisle, PA (US); Jordan OLIVIO, Carlisle, PA (US); Ying LIANG, Lake Jackson, TX (US); Jessica KOGLER, Carlisle, PA (US)

(73) Assignee: CARLISLE CONSTRUCTION MATERIALS, LLC, Carlisle, PA (US)

(21) Appl. No.: 19/292,107

(22) Filed: Aug. 6, 2025

Related U.S. Application Data
(60) Provisional application No. 63/687,946, filed on Aug. 28, 2024.

(51) Int. Cl. E04D 5/10; B32B 5/02; B32B 5/18; B32B 5/24; B32B 27/06; B32B 27/12; B32B 27/30; B32B 27/32

(52) U.S. Cl. CPC E04D 5/10; B32B 5/028; B32B 5/18; B32B 5/245; B32B 27/065; B32B 27/12; B32B 27/304; B32B 27/32; B32B 2250/04; B32B 2262/0276; B32B 2262/101; B32B 2264/02; B32B 2264/101; B32B 2264/2032; B32B 2266/0235; B32B 2266/025; B32B 2266/08; B32B 2419/06

(57) ABSTRACT

An enhanced performance roofing membrane, having: (a) a bottom membrane layer; (b) a top membrane layer; (c) a scrim layer between the top and bottom membrane layers; and (d) a reduced density membrane layer between the top and bottom membrane layers. The reduced density membrane layer may be a foamed layer, or a layer of polymer with gas pockets or beads therein. The reduced density layer may be made of the same materials as the top and bottom layers.

### RELATED APPLICATION

The present application claims priority to U.S. Provisional Patent Application Ser. No. 63/687,946, of same title, filed Aug. 28, 2024, the entire disclosure of which is incorporated herein by reference in its entirety for all purposes.

### TECHNICAL FIELD

The present invention relates to TPO and PVC roofing membranes.

### BACKGROUND OF THE INVENTION

Lightweighting refers to the process of decreasing the weight of a manufactured product, which serves to enhance environmental sustainability and cut expenses throughout the supply chain. Reducing material usage is a cornerstone of sustainable practices, often referred to as resource efficiency. By utilizing fewer raw materials in manufacturing and construction, there is a direct conservation of resources, which diminishes the depletion of non-renewable materials and lessens the pressure on renewable resources, allowing them to regenerate. This reduction minimizes the environmental impact of extraction processes, including energy consumption, habitat disruption, and pollution. Additionally, using less material reduces waste production and the associated costs and environmental impacts of waste management and disposal. It also encourages innovation in design, prompting the development of products that are not only more resource-efficient but often more advanced and functional. Overall, material reduction supports a transition towards a more circular economy, where the lifecycle of materials is extended, and their value is maximized, leading to a harmonious balance between economic development and environmental stewardship.

Minimizing the weight of roofing membranes simplifies the handling of materials throughout the transport and installation processes. Such lightweighting means that less material is required to achieve the same area of waterproofing coverage. This reduction in weight can also lead to decreased fuel consumption and emissions during transportation of roofing membrane to the construction sites, as lighter loads require less energy for vehicles to accelerate and maintain speed. Additionally, lighter transportation loads result in reduced impact on roads and infrastructure, leading to fewer needs for repairs and maintenance, thereby preserving resources. Furthermore, lighter loads contribute to improved fuel efficiency, which is instrumental in lowering greenhouse gas emissions, an essential aspect of combating climate change.

TPO roofing is a single-ply rubber-like roofing membrane that is made of three bound sheets; having a thermoplastic bottom layer, a middle polyester fabric center (i.e.: scrim), and a thermoplastic top layer. During manufacture, the top and bottom thermoplastic layers are simply heated and bond together (by a lamination process) with one another through the holes in the center fabric scrim. The scrim gives the TPO membrane its strength and puncture resistance and is responsible for the membrane's dimensional stability. The top thermoplastic layer typically has UV blockers and abrasion-resistant additives. Thermoplastic roofing membranes are quite thin and are commonly sold in gauges of 45 mil, 60 mil, and 80 mil, which are 0.045″,0.06″, and 0.08″ thick, respectively. Rolls usually come in widths of six, eight, ten, twelve and sixteen feet, at varying lengths.

It is important when reducing the amount of TPO or PVC in the roofing membrane that the resulting roofing membrane does not exhibit weakened or compromised properties. For example, if the amount of TPO or PVC per square foot of roofing membrane is simply reduced, it is important that the strength and durability of the roofing membrane not be reduced as well. As will be shown, the present system reduces the amount of TPO or PVC roofing material used in its manufacture, but also provides surprising advantages.

### SUMMARY OF THE INVENTION

The present invention provides an enhanced performance roofing membrane; comprising:
a bottom membrane layer;
a top membrane layer;
a scrim layer between the top and bottom membrane layers; and
at least one reduced density membrane layer between the top and bottom membrane layers.

In various preferred aspects, the reduced density layer may be a foamed membrane layer. It is to be understood, however, that the present reduced density layer may include any polymer membrane layer having gas pockets therein. In various aspects, the gas may be air, nitrogen or carbon dioxide. It is to be understood that the present system includes any suitable gas or combination of gasses in the pockets in the membrane. In alternate aspects, the reduced density membrane layer is a polymer membrane layer having beads therein. Optionally, these beads may be made of glass, plastic, a thermoplastic or ceramic material and they may be hollow.

Preferably, each of the top, bottom and reduced density layers are all made of the same matrix material which is preferably TPO or PVC. In one preferred embodiment, the scrim layer is positioned directly above the foamed or reduced density layer. In another preferred embodiment, the scrim layer is positioned directly below the foamed or reduced density layer. In yet another preferred embodiment, the scrim layer is positioned between two foamed or reduced density layers that are in turn positioned between the top and bottom membrane layers.

The addition of the reduced density layer(s) reduces the amount of material used in manufacturing the roofing membrane. Simply put, including air or gas bubbles or beads such as glass or plastic beads within the layers of the roofing membrane reduces the density of the roofing membrane in these locations (as compared to a solid TPO or PVC membrane of the same thickness). This surprisingly makes the overall membrane assembly more sustainable. In addition, reducing the density of the roofing membrane (by incorporating one or two reduced density layers therein) also makes it more lightweight. This also makes it more energy efficient to ship and to install.

A surprising benefit of the present lower density lightweight roofing membrane is that it exhibits enhanced mechanical performance. Specifically, the addition of the foamed or reduced density layer provides the surprising advantage of increasing the impact resistance of the roofing membrane to hail. This is a surprisingly result because increased hail resistance is achieved in a thin roofing membrane assembly. In fact, the hail resistance provided by the present system may be sufficient for even very severe hail such that additional coverboards do not need to be installed between the insulation boards and the roofing membrane at all.

Another benefit of the present lower density lightweight roofing membrane is that it provides exceptional flexibility and ease of handling during roof installation. Yet another advantage of the present low density lightweight roofing membrane is that it provides improved insulation properties. This will help to reduce energy consumption for heating and cooling, leading to lower utility bills and a reduced environmental footprint.

To manufacture the present roofing membrane, the reduced density layer can be foamed onto or extruded together with one of the top or bottom layers. If such a foam layer is foamed onto or extruded together with the top layer, then the top layer may be extruded on top of the scrim layer. After each of the top and foamed layers or bottom and foamed layers are extruded, the top, bottom, foam and scrim layers can all be passed together through a laminator machine to fuse either the top or bottom layers to the foam layer through the scrim layer. In additional embodiments, two foamed layers are provided with a foamed layer above and below a central scrim layer. The foamed layer can be produced by adding gas bubbles into a TPO or PVC starting material. These gas bubbles may be produced via a physical foaming process or by a foaming agent reaction. Such a foaming agent reaction may be an endothermic or exothermic reaction.

### BRIEF DESCRIPTION OF THE DRAWINGS

FIG. 1A is a perspective illustration of a TPO membrane being used in a mechanically fastened roofing system.

FIG. 1B is a perspective illustration of a TPO membrane being used in a fully adhered roofing system.

FIG. 2 is a perspective illustration of a conventional TPO roofing membrane.

FIG. 3A is a sectional side elevation view of a membrane assembly according to the present system with a scrim layer positioned between the bottom layer and the reduced density layer.

FIG. 3B is a sectional side elevation view of a membrane assembly according to the present system with a scrim layer positioned between the top layer and the reduced density layer.

FIG. 4 is a sectional side elevation view of a five-layer membrane assembly according to the present system having a reduced density layer both above and below a central scrim layer.

FIG. 5 is an optical microscopy photo of a foamed layer in transmission mode for a lower density membrane sample.

FIG. 6 is an optical microscopy photo of a foamed layer in transmission mode for a higher density membrane sample.

FIG. 7 is a Scan electron microscopy (SEM) photo of a foamed layer cross section for a lower density membrane sample.

FIG. 8 is a Scan electron microscopy (SEM) photo of a foamed layer cross section for a higher density membrane sample.

FIG. 9 is a Scan electron microscopy (SEM) photo of a multi-layer construction cross section for a roofing sample corresponding to FIG. 3A.

FIG. 10 is a Scan electron microscopy (SEM) photo of multi-layer construction cross section for a roofing sample corresponding to FIG. 3B.

### DETAILED DESCRIPTION OF THE DRAWINGS

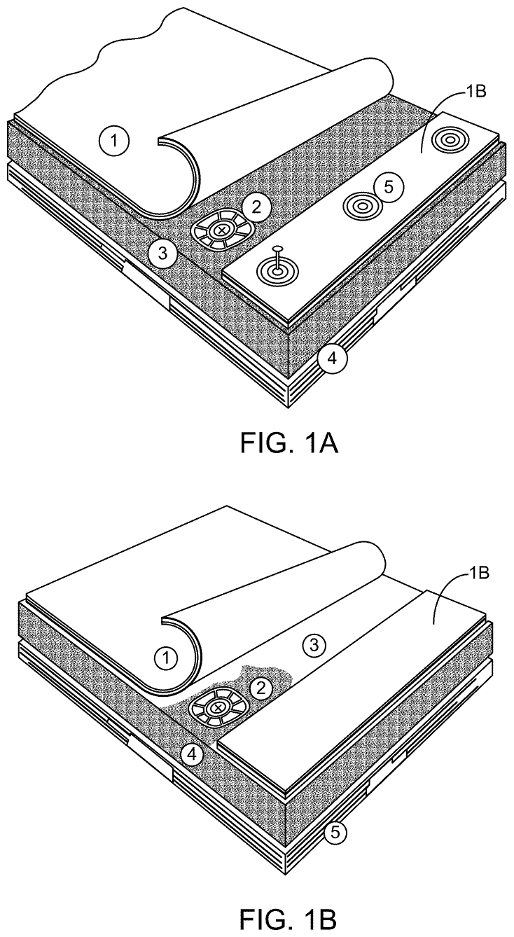

FIGS. 1A and 1B illustrate a TPO membrane 1 being mechanically fastened (FIG. 1A) or fully adhered (FIG. 1B) onto a roof. In both systems, an insulation board 3 is first attached to a roof deck 4 by a series of mechanical fasteners 2 which are spread across the roof (only one is shown here for clarity of illustration).

In FIG. 1A, TPO membrane 1 is then “Mechanically Fastened” at its edges to membrane fasteners and plates 5 (which are shown securing down the edge of an adjacent TPO membrane 1B. In FIG. 1B, TPO membrane 1 is “Fully Adhered” across the entire surface of the roof by a bonding adhesive 6. The overlapping edges of TPO membranes 1 and 1B can be adhered together, or thermally bonded together, as desired to prevent water leaks therebetween.

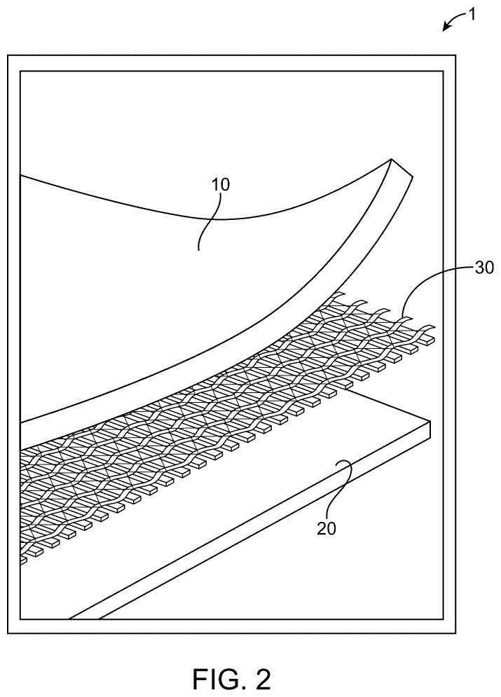

FIG. 2 is an illustration of a typical TPO roofing membrane assembly 1. As can be seen, a conventional TPO membrane is a three-layer assembly having a TPO top ply layer 10 and a TPO bottom ply layer 20. These top and bottom layers 10 and 20 are typically formed by extrusion. A scrim layer 30, which is typically made of polyester or a fiberglass-reinforced fabric is then placed between the top and bottom layers 10 and 20. The entire three-layer assembly 1 is then passed through a laminating machine which heats the assembly causing the top and bottom layers 10 and 20 to fuse together (through the openings in the netting of scrim 30). Such traditional TPO membranes are sturdy and provide excellent waterproofing. They are also quite thin, being on the order of 0.045″ to 0.08″ thick. Unfortunately, these conventional roofing membranes are typically not strong enough to protect the insulation below from Very Severe Hail storms. As a result, coverboards are often installed between the insulation boards and the TPO roofing membranes to withstand Very Severe Hail.

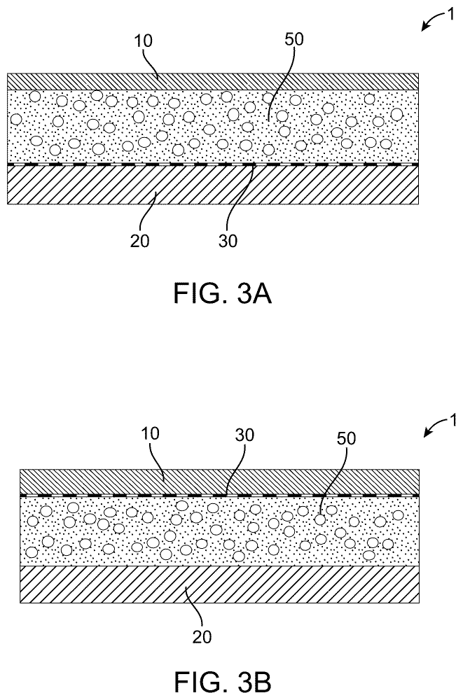

As seen in FIGS. 3A and 3B, the present system includes a reduced density layer 50 in the TPO (or PVC) membrane assembly. This reduced density layer 50 may be a foamed layer that is made of the same material (i.e.: TPO or PVC) as the top and bottom layers 10 and 20. Foamed layer 50 can be positioned above or below scrim layer 30. In FIG. 3A, scrim layer 30 is positioned between bottom layer 20 and foamed layer 50. This membrane assembly design may be formed by placing scrim 30 on top of bottom layer 20 while separately foaming (typically co-extruding) foamed layer 50 onto top layer 10. This may be done by first foaming foamed layer 50 onto top layer 120 and then turning top and foamed layers 10 and 50 upside down so that foamed layer 50 is now positioned on the bottom (and is therefore placed on top of scrim layer 30). Passing the assembly 1 through a laminator machine will cause the foamed and bottom layers 50 and 20 to be heat fused together (through the holes in the scrim netting 30). FIG. 3B is an illustration of a second embodiment of the present system with scrim layer 30 between top layer 10 and foamed layer 50. In this embodiment, foamed layer 50 is foamed (typically co-extruded) onto bottom layer 20. Next, scrim layer 30 is placed on top, and top layer 10 is then placed on top of scrim layer 30. Finally, the entire assembly 1 is then passed through a laminator machine such that top layer 10 and foamed layer 50 will be heat fused together (through the holes in the scrim netting 30).

Foamed layer 50 is preferably produced by adding gas bubbles into a TPO or PVC material. These are produced by a foaming (or “blowing”) agent reaction that may be an endothermic reaction. These foaming agents impart a cellular structure to the material. In preferred aspects, a reaction as simple as baking soda (i.e.: sodium bicarbonate)+citric acid react when mixed with water to form some amount of carbon dioxide gas as the foaming agent. The present system contemplates different blowing or foaming agents, all keeping within the scope of the present invention. Both chemical and physical blowing agents, or mixtures thereof are contemplated in the present system.

The first advantage of using a reduced density layer such as a foamed layer is that it reduces the density of the TPO or PVC material used in making the roofing membrane. Thus, the roofing membrane is lighter-weight and easier to work with. A second advantage of using a foamed layer is that it advantageously provides impact resistance (all without adding considerable weight to the assembly). Specifically, a surprising advantage of the present system is that it can avoid the use of coverboards by providing a sufficiently strong TPO (or PVC) roofing membrane that is able to withstand Factory Mutual's 4470's procedure for Very Severe Hail Testing. Factory Mutual's 4470's procedure for Very Severe Hail Testing is a new test standard that has had a significant impact on the construction of commercial roof systems in fourteen states throughout the Midwest. Many roof systems are unable to achieve the VSH rating due to various modes of failures. As a result, there is a desire in the industry to improve the hail impact resistance of roof systems. The advantage of the present system of using one or two foamed TPO or PVC layers in the roofing membrane is that such foamed layers provide increased hail resistance. In contrast, a common prior art approach to strengthening the roof had been to place coverboards over the top of the roofing insulation and then place the roofing membrane over the coverboards. The disadvantage of such coverboards is their added cost to the roof assembly (both in terms of the physical material itself and in terms of its installation costs).

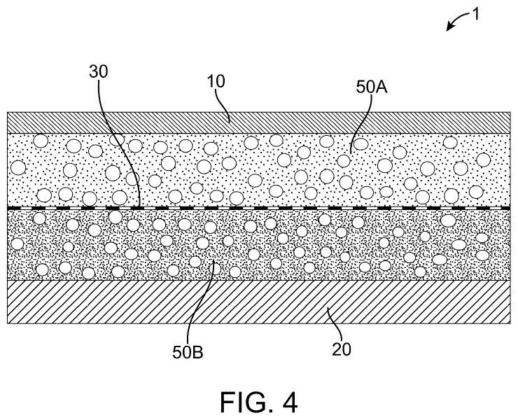

FIG. 4 shows a five-layer roofing membrane having a foamed layer 50A above scrim layer 30 and a foamed layer 50B below central scrim layer 30. In this embodiment, first foamed layer 50B is foamed (typically co-extruded) onto bottom layer 20 and second foamed layer 50V is foamed (typically co-extruded) onto top layer 10. A scrim layer 30 is then placed between foamed layers 50A and 50B and the entire assembly 1 is then passed through a laminator. This will cause the two foamed layers 50A and 50B to be heat fused together (through the holes in the scrim netting 30).

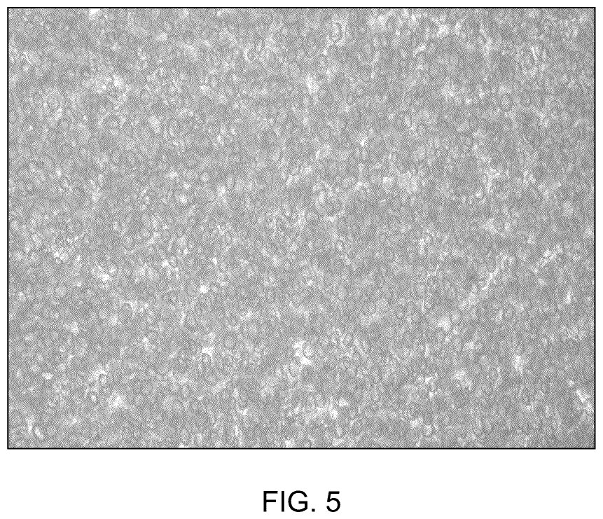

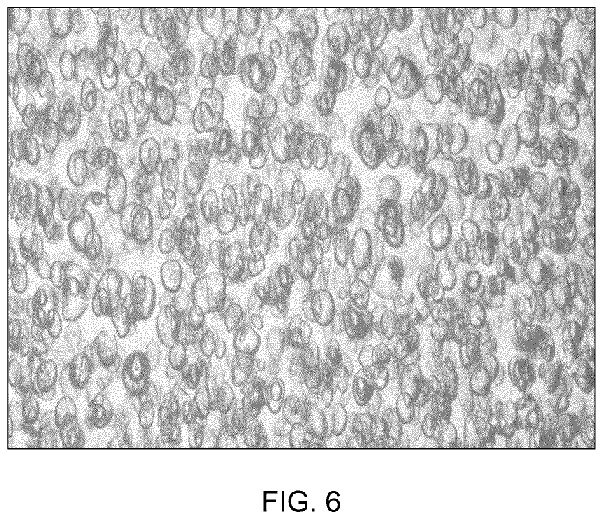

FIG. 5 is optical microscopy of foamed layer in transmission mode for a high foam density sample. FIG. 6 is optical microscopy of foamed layer in transmission mode for a low foam density sample. As can be seen comparing these two Figures, FIG. 5 has more gas bubbles in the material (and therefore is a lower density membrane).

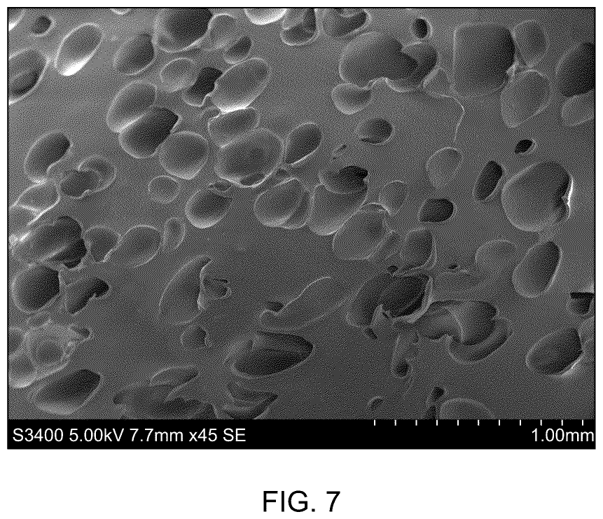

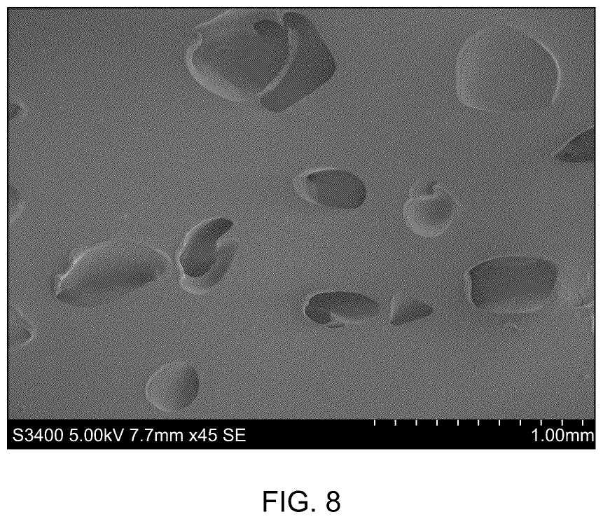

FIG. 7 is a Scan electron microscopy (SEM) of foamed layer cross section for a high foam density sample. FIG. 8 is a Scan electron microscopy (SEM) of foamed layer cross section for a low foam density sample. As can be seen comparing these two Figures, FIG. 7 has more gas bubbles in the material (and therefore is a lower density membrane).

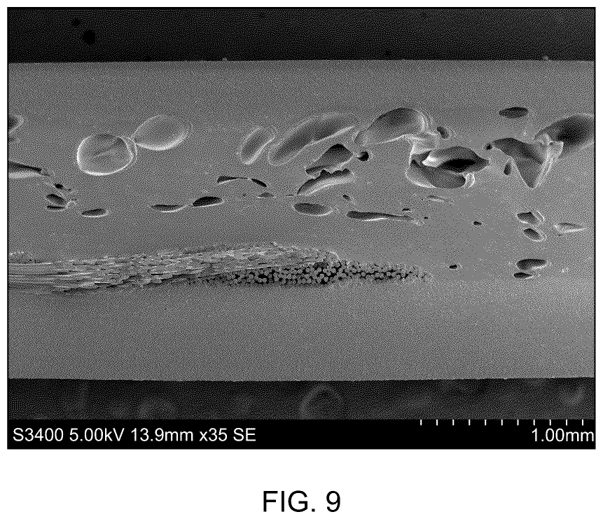

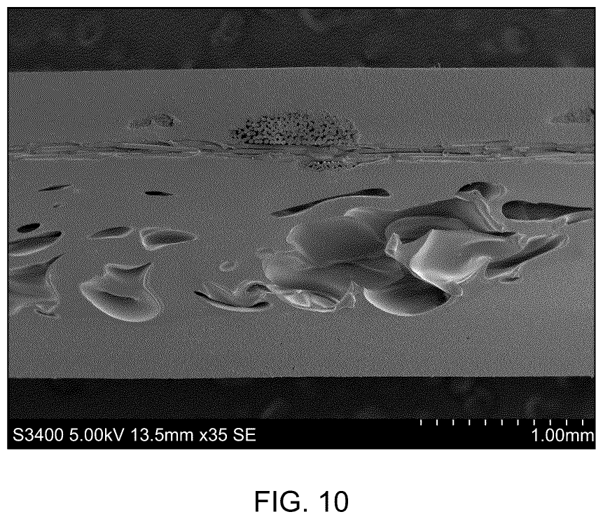

FIG. 9 is a Scan electron microscopy (SEM) of multi-layer construction cross section for a roofing sample corresponding to the left side of FIG. 3. showing the scrim layer positioned between the bottom and the foamed layers.

Table 1 below shows a simple formulation for the present foam layer of the lightweight roofing membrane.

TABLE 1

| | Ref. 1 | Example 1 | Example 2 | Example 3 | Ref. 2 | Example 4 | Ref. 3 | Example 5 |
|---|---|---|---|---|---|---|---|---|
| Hifax CA10A (%) | 100.0 | 99.0 | 98.5 | 98.5 | | | | |
| Adflex V109 (%) | | | | | 100 | 99 | | |
| PP7073E2 | | | | | | | 100 | 99 |
| Chemical foaming | 0.0 | 1.0 | 1.5 | 1.5 | | 1 | | 1 |
| concentrate | | | | | | | | |
| Total | 100.0 | 100.0 | 100.0 | 100.0 | 100.0 | 100.0 | 100.0 | 100.0 |

Table 2 below shows the weight difference between a foamed formulation (in accordance with the present system) vs. a non-foamed formulation (made in accordance with prior art methods) for formulations in Table 1. The specific density is measured in accordance with ASTM D792 Standard Test Methods for Density and Specific Gravity (Relative Density) of Plastics by Displacement. The mass per unit is measured in accordance with a modified method based on ASTM D751 Standard Test Methods for Coated Fabrics.

TABLE 2

| | Ref. 1 | Example 1 | Example 2 | Ref. 2 | Example 4 | Ref. 3 | Example 5 |
|---|---|---|---|---|---|---|---|
| Specific density* | 1.08 | 0.83 | 0.86 | 1.07 | 0.83 | 1.01 | 0.82 |
| Weight reduction based on | — | 23% | 20% | — | 23% | — | 19% |
| specific density results | | | | | | | |
| Thickness of foam (inch) | 0.0434 | 0.0440 | 0.0370 | 0.0240 | 0.0310 | 0.0220 | 0.0310 |
| Mass per unit (lb/ft3)** | 49.80 | 36.70 | 38.00 | 51.00 | 42.41 | 48.95 | 36.69 |
| Weight reduction based on | — | 26% | 24% | — | 17% | — | 25% |
| mass per unit results | | | | | | | |

Table 3 below shows the extrusion of foamed layer can be performed on either a single screw extruder (SSE) or a twin screw extruder (TSE) and the properties of the foamed layer are similar.

TABLE 3

| | | SSE | TSE |
|---|---|---|---|
| | Ref. 1 | Example 2 | Example 3 |
| Specific density* | 1.08 | 0.86 | 0.895 |
| Weight reduction based on | — | 20% | 17% |
| specific density results | | | |
| Thickness of foam (inch) | 0.0434 | 0.0370 | 0.038 |
| Mass per unit (lb/ft3)** | 49.80 | 38.00 | 41.21 |
| Weight reduction based on | — | 24% | 17% |
| mass per unit results | | | |

Table 4 below shows a more complex formulation for the present foam layer of lightweight roofing membrane.

TABLE 4

| | Ref. 4 | Example 6 | Example 7 | Ref. 5 | Example 8 | Example 9 |
|---|---|---|---|---|---|---|
| Hifax CA10A (%) | 92.8 | 91.8 | 91.3 | 60.8 | 59.8 | 59.3 |
| Stabilizer and flame | 7.2 | 7.2 | 7.2 | 39.2 | 39.2 | 39.2 |
| retardant Concentrate | | | | | | |
| Chemical foaming | 0.0 | 1.0 | 1.5 | 0.0 | 1.0 | 1.5 |
| concentrate | | | | | | |
| Total | 100.0 | 100.0 | 100.0 | 100.0 | 100.0 | 100.0 |

Table 5 below shows the weight difference between a foamed formulation (in accordance with the present system) vs. a non-foamed formulation (made in accordance with prior art methods) for formulations in Table 4.

TABLE 5

| | Ref. 4 | Example 6 | Example 7 | Ref. 5 | Example 8 | Example 9 |
|---|---|---|---|---|---|---|
| Thickness of foam (inch) | 0.0434 | 0.0370 | 0.038 | 0.040 | 0.039 | 0.038 |
| Mass per unit (lb/ft3)** | 56.60 | 43.58 | 44.80 | 66.17 | 49.87 | 47.24 |
| Weight reduction based on | — | 23% | 21% | — | 25% | 29% |
| mass per unit results | | | | | | |

It is to be understood that the present system encompasses not only foamed layers as reduced density layers 50. Rather, it is to be understood that any reference to “foamed” herein equally applies to any form of reduced density layers, including but not limited to any polymer membrane layer that has gas pockets therein. In various embodiments, the gas in these pockets or bubbles may comprise air, nitrogen, carbon dioxide or any other suitable gas or combination of gasses.

In further alternative embodiments, the reduced density membrane layer 50 is broadly understood to be any polymer membrane layer having beads therein. These beads may be made of glass, plastic, thermoplastic or ceramic and they may be hollow. Such beads may also help enhance dimensional stability of the membrane and reduce shrinkage.

In various embodiments set forth herein, the top, bottom and reduced density layers 10, 20 and 50 may all made of the same type of material. As such, reduced density layer 50 may be any form of material used in making top and bottom layers 10 and 20 but having a lower density, all keeping within the scope of the present system.

What is claimed is:

1. An enhanced performance roofing membrane, comprising:
a bottom membrane layer;
a top membrane layer;
a scrim layer between the top and bottom membrane layers; and
a reduced density membrane layer between the top and bottom membrane layers, wherein the reduced density membrane layer has a density less than either of the top or bottom layers.

2. The roofing membrane of claim 1, wherein the reduced density membrane layer is a foamed membrane layer.

3. The roofing membrane of claim 1, wherein the reduced density membrane layer is a polymer membrane layer having gas pockets therein.

4. The roofing membrane of claim 3, wherein the gas comprises air, nitrogen or carbon dioxide.

5. The roofing membrane of claim 1, wherein the reduced density membrane layer is a polymer membrane layer having beads therein.

6. The roofing membrane of claim 5, wherein the beads are made of glass or plastic.

7. The roofing membrane of claim 5, wherein the beads are hollow.

8. The roofing membrane of claim 1, wherein the top, bottom and reduced density layers are all made of the same type of material.

9. The roofing membrane of claim 8, wherein the top, bottom and reduced density layers are all made of TPO or PVC.

10. The roofing membrane of claim 1, wherein the scrim layer is directly above the reduced density layer.

11. The roofing membrane of claim 10, wherein:
the reduced density layer is spread onto the bottom layer,
the scrim layer is placed onto the reduced density layer, and then
the top layer is placed onto the scrim layer, and then
the top layer and reduced density layer are heat fused together through the scrim layer by passing the roofing membrane through a laminator.

12. The roofing membrane of claim 1, wherein the scrim layer is directly below the reduced density layer.

13. The roofing membrane of claim 12, wherein:
the reduced density layer is spread onto the top layer,
the scrim layer is placed onto the bottom layer,
the top and reduced density layers are flipped over and placed on top of the scrim layer so that the reduced density layer is on top of the scrim layer; and then
the bottom layer and reduced density layer are heat fused together through the scrim layer by passing the roofing membrane through a laminator.

14. The roofing membrane of claim 1, wherein each of the top and bottom layers are formed in an extrusion process.

15. The roofing membrane of claim 2, wherein the foamed layer is produced by adding gas bubbles into a TPO or PVC material.

16. The roofing membrane of claim 15, wherein the gas bubbles are produced by a foaming agent reaction.

17. The roofing membrane of claim 16, wherein the foaming agent reaction is an endothermic reaction.

18. The assembly of claim 1, wherein the scrim layer is made of polyester or a fiberglass-reinforced fabric.
